(19) United States
(12) Patent Application Publication
(10) Pub. No.: US 2006/0225081 A1
(43) Pub. Date: Oct. 5, 2006

(54) Method for managing a peripheral and computer system using same

(76) Inventor: Etienne Annic, Rambouillet (FR)

Correspondence Address: Brian J Colandreo;Grossman Tucker Perreault & Pfleger, 55 South Commercial Street, Manchester, NH, 03101, US

(21) Appl. No.: 10/541,689

(22) PCT Filed: Jan. 8, 2004
(86) PCT No.: PCT/FR04/00023

§ 371 Date: Apr. 6, 2006

(30) Foreign Application Priority Data
Jan. 9, 2003 (FR) 03/00188

(51) Int. Cl. G06F 9/46; G06F 3/00

(52) U.S. Cl. 719/321; 710/36

(57) ABSTRACT

The invention concerns a method for managing a peripheral enabling direct transmission by the source equipment (1), through a network interface (10), without their being treated by a peripheral pilot, data (2) written in a content description language. The peripheral (3) interprets the data reviewed by a network interface (11) by means of a software (4) which transmits the interpreted data to the peripheral pilot (5) which then manages same. The source equipment and the peripheral are network-connected (9).

The present invention relates to a method of managing a peripheral. It also relates to a computer system using this method.

Hitherto, the transmission of data to a peripheral has been done by means of two peripheral drivers, the one installed on the source equipment, in this instance a computer, which may despatch a command to the peripheral, and the other directly on the peripheral, in particular a printer.

Thus, the data transmitted to the peripheral are firstly processed by the driver installed at the computer, then transmitted to the peripheral, in a form interpretable by the peripheral's own driver. The peripheral then processes the data received by means of its own driver, and formulates instructions for executing a command corresponding to the data.

The driver is a computer program responsible for ensuring an interface between two pieces of equipment by tailoring the data transmitted by the source equipment so as to be intelligible by the destination equipment.

There are almost as many drivers of a type of peripheral as there are marketed types of this peripheral, multiplied by the number of operating systems of the source equipment existing on the market.

This compels the user to instal the peripheral driver corresponding to his peripheral and to the version of the operating system of his source equipment. This driver sometimes does not exist.

This also makes it compulsory to keep a large number of drivers up to date for each peripheral.

Thus, in view of the foregoing, the aim of the invention is to provide a method of managing a peripheral not requiring the use of a driver of this peripheral on the source equipment.

Hence, according to the invention, there is proposed a method of managing a peripheral consisting in:
transmitting data written by means of a content description language to the peripheral;
interpreting the data by means of interpretation software hosted within the peripheral; and
translating the interpreted data into data for controlling the peripheral by means of a driver hosted within the peripheral.

Thus, no driver of the peripheral is used in the source equipment, thereby avoiding the need to update a very large number of drivers on each piece of source equipment using the peripheral.

According to a mode of implementation of this method, the result of the processing of the data by the interpretation software of the peripheral is stored in means of storage of the peripheral.

According to a mode of implementation of this method, in the course of the data writing step, the data is separated into content description data and presentation or form description data. Included within the content description data is an addressing indicating the location of the presentation description data of said content description data. During the interpretation step the addressed presentation description data are retrieved.

Advantageously, the presentation description data are stored within a server identified by the addressing.

Furthermore, the presentation description data are transmitted to the peripheral as a function of the characteristics of the peripheral. This makes it possible to customize the response as a function of the characteristics of the peripheral.

Furthermore, the characteristics of the peripheral are conveyed by a header of a message of the communication protocol used to convey the data.

According to a mode of implementation of the method, the content description language is, for example, a hypertext markup language.

The interpretation software is, for example, a web browser.

According to the invention, there is also proposed a peripheral management system comprising at least one computer and one printer attached in a network.

The computer comprises means for transmitting data written in a content description language to the printer, and the printer comprises interpretation software and a printer driver for translating the interpreted data into the form of printing control data. It is thus possible to download a file from a server and transmit this file, for example a web page, to the printer, which formulates the printing commands on the basis of the data interpreted in the content description language.

According to another characteristic of the system according to the invention, the latter furthermore comprises a server hosting the data written in a content description language and a set of presentation description files of content description data corresponding to the set of data hosted in the server.

The content description data may contain an addressing indicating the location of the content data presentation description file, hosted in the server, and the name of this file. The interpretation software of the printer comprises means for retrieving this presentation description file on the server on the basis of said addressing.

According to another characteristic of the system according to the invention, the printer comprises means for communicating identifying characteristics of said printer to the server. The server comprises means for processing the characteristics of the printer so as to transmit thereto a version of the presentation description file corresponding to the characteristics of the printer.

Preferably, the characteristics of the printer are conveyed in a header of a protocol employed for the transfer of the file, for example the HTTP “HyperText Transfer Protocol” protocol standardized by the IETF “Internet Engineering Task Force”.

According to an embodiment, the addressing of the presentation description file is, for example, a URI “Uniform Resource Identifier” address standardized by the IETF.

According to an embodiment, the content description language is, for example, the X-HTML “eXtended HyperText Markup Language” language standardized by the consortium known by the title W3C “World Wide Web Consortium”, and the presentation description language is, for example, the CSS “Cascading Style Sheet” language standardized by the W3C.

Other aims, characteristics and advantages of the invention will become apparent on reading the following description, given merely by way of nonlimiting example, and offered with reference to the appended drawings in which:

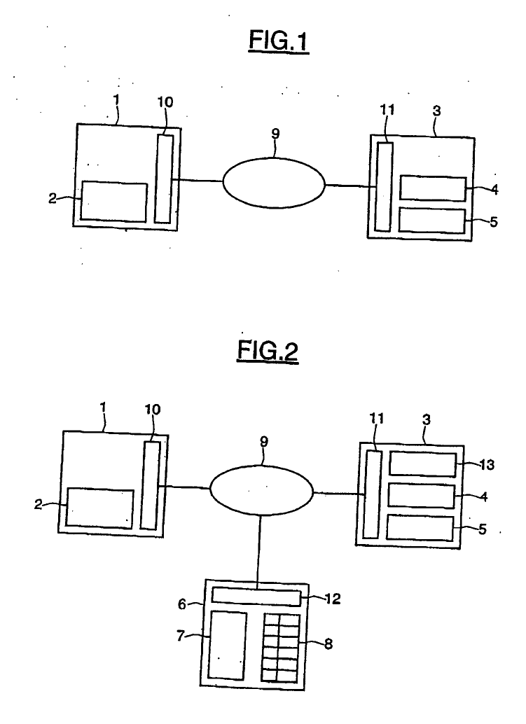

FIG. 1 is a schematic diagram illustrating a computer system according to the invention.

FIG. 2 is a schematic diagram illustrating another embodiment of the computer system of FIG. 1.

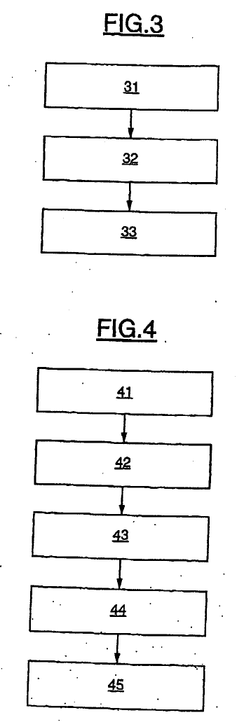

FIG. 3 is a flowchart illustrating a management method used by the computer system of FIG. 1.

FIG. 4 is a flowchart illustrating a management method used by the computer system of FIG. 2.

With reference to FIG. 1, the computer system according to the invention comprises a source piece of equipment 1, for example a computer, and a peripheral 3 consisting of a printer. The invention applies however to any type of peripheral. The two pieces of apparatus are linked as a network 9.

The printer 3 is provided with means of storage into which are loaded data transmitted by the computer 1, and software means allowing the reception of data emanating from the computer 1 and their processing so as to cause the printing of a file received.

In particular, these software means comprise software 4 for interpreting the data transmitted by the computer 1, as well as a printer driver 5, and are supplemented with a network interface 11.

The computer 1 for its part comprises all the hardware and software means making it possible to exchange data with the printer, including a network interface 10, as is known per se.

It furthermore comprises means making it possible to transmit to the printer data to be printed written in a content description language.

For this purpose, for example, use is made of a hypertext markup language (X-HTML) which makes it possible to describe a file using a set of markers.

According to a first embodiment, represented in FIG. 1, the file thus formulated contains, on the one hand content description data and, on the other hand, presentation description data.

However, as shown by FIG. 2 which diagrammatically illustrates another embodiment of a computer system according to the invention, this system furthermore comprises a server 6 which contains a set 8 of presentation description files. Each file corresponds to a type of printer to be used.

The computer furthermore comprises means for transmitting the data to be printed by the network interface 10 in the form of a content description file associated with an address, for example a URI address, serving for the addressing of the presentation description file.

The content description language is, for example, the X-HTML 1.1 language, and the presentation description language is, for example, the CSS 2.0 language.

To allow the printer to provide indications pertaining to its characteristics, it comprises software 13 capable of inserting information into the header of signals of the protocol used to convey the data from the printer 3 to the server 6.

To detect the nature of this printer, the server 6 comprises software 7 capable of processing the characteristics of the printer 3 that are inserted by the software 13 and transmitted by the network interface 11.

A transmission of a document to be printed to the printer 3 will now be described with reference to FIG. 3.

The transmission begins with a first step 31 in the course of which the computer 1 transmits the data file (document) to be printed, by the network interface 10, in a content description language, to the network interface 11 of the printer 3. Data interpretation software 4 interprets them (step 32) and transmits the interpreted data to the printer driver 5. The driver 5 translates these interpreted data into printer control data (step 33), so as to control the printing of the document.

With reference to FIG. 4, in another embodiment of the method according to which a server is used, the transmission begins with a first step 41 in the course of which the computer 1 transmits by the network interface 10 to the network interface 11 of the printer 3 the data (document) to be printed, in a content description language suitable for separating the content description and the presentation description.

As indicated previously, the data transmitted take the form of a content description file comprising an addressing of the presentation description file allowing the retrieval of the presentation description file corresponding to the printer.

Data interpretation software 4 interprets the content description file (step 42), downloads the presentation description file by means of the addressing included in the content description file (step 43), interprets the presentation description file (step 44) then transmits the interpreted data to the printer driver 5. The driver 5 translates these interpreted data into printer control data (step 45), so as to control the printing of the document.

Step 43 of downloading the presentation description file is performed in several phases. Firstly the software 4 makes a request to download the presentation description file to the network interface 11, then the network interface 11 transmits the download request to the network interface 12 of the server 6. The software 7 transmits the file requested by the network interface 12 of the server 6 to the network interface 11 of the printer 3, which transmits it to the data interpretation software 4 which interprets it.

In another embodiment of step 43 according to the invention, the printer 3 transmits via the interface 11 its characteristics inserted by the software 13 to the network interface 12 of the server 6, by means of the header of a message of the communication protocol chosen to convey the data. The server 6 is then equipped with software 7 capable of processing the characteristics of the printer, and of transmitting thereto a version of the presentation description file corresponding thereto.

Step 43 then comprises extra phases. Specifically, additionally, the software 13 transmits to the interface 11 the characteristics of the printer for insertion into the header of the protocol, these characteristics are analyzed by the software 7 which proceeds to the selection of the file corresponding to the request and to the characteristics of the printer 3.

1. A method of managing a peripheral comprising:
transmitting data written by means of a content description language to the peripheral;
interpreting the data by means of interpretation software hosted within the peripheral; and
translating the interpreted data into data for controlling the peripheral by means of a driver hosted within the peripheral.

2. The method of managing a peripheral as claimed in claim 1, wherein the result of the processing of the data by the interpretation software is stored in a means of storage of the peripheral.

3. The method of managing a peripheral as claimed in claim 1, wherein in the course of the data writing step, the data is separated into content description data and presentation description data, and included within the content description data is an addressing indicating the location of the presentation description data of said content description data, and in that the interpretation step comprises a step of retrieving the addressed presentation description data.

4. The method of managing a peripheral as claimed in claim 3, wherein the data written by means of the content description language are hosted in a server and in that the presentation description data are stored in said server identified by the addressing.

5. The method of managing a peripheral as claimed in claim 4, wherein the presentation description data are transmitted to the peripheral as a function of the characteristics of said peripheral.

6. The method of managing a peripheral as claimed in claim 5, wherein the characteristics of the peripheral are conveyed by a header of a message of the communication protocol used to convey the data.

7. The method of managing a peripheral as claimed in claim 1, wherein the content description language is a hypertext markup language.

8. The method of managing a peripheral as claimed in claim 1, wherein the interpretation software is a web browser.

9. A computer system comprising at least one computer and a printer that are attached in a network, wherein the computer comprises means for transmitting data written in a content description language to the printer, and in that the printer comprises software for interpreting the data transmitted and a printer driver for translating the interpreted data into the form of printing control data.

10. The computer system as claimed in claim 9, further comprising a server hosting the data written in a content description language, a set of respective presentation description files corresponding to the set of data hosted within the server, and in that the content description data comprise an addressing indicating the location of a content description data presentation description file stored in the server and the name of this file, and in that the interpretation software comprises means for retrieving the presentation description file on the server on the basis of said addressing.

11. The computer system as claimed in claim 10, wherein the printer comprises means for communicating identifying characteristics of said printer to the server, and in that the server comprises means for processing the characteristics of the printer so as to transmit thereto a version of the presentation description file corresponding to the characteristics of the printer.

12. The computer system as claimed in claim 11, wherein the characteristics of the printer are conveyed by a header of an HTTP hypertext transfer protocol.

13. The computer system as claimed in claim 10, wherein the addressing of the data description file is a URL address.

14. The computer system as claimed in claim 10, wherein the content description language is the X-HTML language and the presentation description language is the CSS language.
